(19) United States
(12) Patent Application Publication
(10) Pub. No.: US 2022/0261767 A1
(43) Pub. Date: Aug. 18, 2022

(54) INTELLIGENT AUTOMATED NOTE TAGGING

(71) Applicant: Dell Products L.P., Round Rock, TX (US)

(72) Inventors: Benedict Tiong Chee Tay, Singapore (SG); Mark John Law, Singapore (SG); Jonathan Sebastian Yarborough Wood, Singapore (SG); Chin Leong Ong, Singapore (SG); Shi Kang Neoh, Singapore (SG)

(73) Assignee: Dell Products L.P., Round Rock, TX (US)

(21) Appl. No.: 17/175,482

(22) Filed: Feb. 12, 2021

(51) Int. Cl. G06Q 10/10; G06F 16/28

(52) U.S. Cl. CPC G06Q 10/1095; G06F 16/285

(57) ABSTRACT

An application of an information handling system may generate a note. The application may request user activity metadata from one or more external sources and may receive user activity metadata from the one or more external sources. The application may tag the note with the received user activity metadata.

### FIELD OF THE DISCLOSURE

The present disclosure generally relates to information handling systems, and more particularly relates to automated tagging of user notes.

### BACKGROUND

As the value and use of information increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

Information handling systems may be used in a variety of settings. Such settings may include the workplace, the classroom, the home, and other settings. For example, some information handling systems may be used for notetaking in meetings, classes, or personal use. Many information handling systems include input interfaces to facilitate notetaking, such as keyboards, physical and/or touch display. Some information handling systems may allow a user to take handwritten notes on touch displays of the information handling systems. For example, a special-purpose stylus or pen may be used to take notes on a touch display of a smart phone or tablet. Alternatively or additionally, information handling systems may allow users to take handwritten notes using a finger on a touch display. Interfaces that allow users to take handwritten notes may allow a user flexibility in notetaking, enhancing a user experience. Notetaking may be particularly useful in academic and workplace and academic settings where users may wish to record details and observations from lectures and/or meetings. Handwritten notes, however, may often lack contextual information, reducing the utility of such notes. For example, a user may create a note, but, when accessing the note at a later time, may not remember one or more details regarding the circumstances under which the note was created.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

Notes generated by an information handling system may be automatically tagged with user activity metadata to provide relevant information about the circumstances under which the note was generated. The user activity metadata may be aggregated from multiple sources to provide a wide breadth of user activity metadata, enhancing the utility of notes generated by a user. For example, if a note is generated during a meeting scheduled on a user's calendar, details about the meeting, such as a name of the meeting, a time of the meeting, a location of the meeting, attendees of the meeting, and other details of the meeting may be retrieved from a backend service or a calendar application on a different information handling system operated by the user and may automatically be tagged to the note. As another example, the information handling system may monitor for other information handling systems within a predetermined range of the information handling system when the note is generated and may automatically tag metadata received from detected additional information handling systems to the note. If a user accesses a document on a laptop associated with the user while generating a note on a tablet, for example, the tablet may retrieve details regarding the document from the laptop and may incorporate such details into the note. Thus, user activity metadata may be automatically tagged to notes generated by a user, to provide the user with relevant contextual information when the notes are accessed in the future.

An example method for tagging notes generated by a user of a first information handling system may include generating, by an application of the first information handling system, such as a notetaking application, a note. For example, a user may open an application executed by the first information handling system and may create a new note or alter an existing note. Thus, generation of a note may include not only creation of a new note but addition of content to or alteration of content within an existing note.

A request may be made, by the application of the first information handling system, for user activity metadata from one or more external sources. For example, the application may request user activity metadata from one or more other applications or background processes executed by the first information handling system. Alternatively or additionally, the application may request user activity metadata from one or more external information handling systems. For example, user activity metadata may be requested from a remote information handling system executing a background process for aggregation of user activity metadata. The background process may communicate with one or more third party services, such as third party calendar or document services, using one or more application programming interfaces (APIs) to receive user activity metadata, such as calendar or appointment metadata. Requested calendar metadata may, for example, include calendar metadata for a time period during which the note was generated. For example, information regarding an appointment during which the note was generated may be requested. In some embodiments, user activity metadata may be metadata including information regarding one or more actions taken by a user while the note was being generated, such as one or more documents opened or edited by the user of the information handling system, a location of the user of the information handling system, a location of a different user of a different information handling system, or other user actions.

As another example, user activity metadata may be requested from one or more additional information handling systems within a predetermined range of the first information handling system. For example, the first information handling system may detect one or more external information handling systems within a predetermined range of the first information handling system. The one or more external information handling systems may be information handling systems associated with a user of the first information handling system or information handling systems associated with a different user. If the additional information handling systems are information handling systems associated with the user of the first information handling system, requested user activity metadata may include metadata regarding one or more files opened or generated by the user while the note was generated. For example, if a user opens a presentation on a laptop of the user while generating a note on a tablet of the user, and the laptop is within the predetermined range of the tablet, the tablet may request and receive user activity metadata regarding the presentation, such as a name of the presentation, a link to a storage location of the presentation, and other information regarding the presentation. If the additional information handling systems are associated with a different user, the first information handling system may request and receive user activity data for the different user. For example, a name of the different user may be received from an additional information handling system and may be incorporated into the generated note. As another example, if the user of the first information handling system has authorization from the different user of the additional information handling system, metadata regarding files, such as documents or notes, accessed by the other user on the additional information handling system may be requested, received, and incorporated into the generated note.

The application of the first information handling system may receive, from the one or more external sources, the requested user activity metadata. For example, the application may receive user activity metadata, such as calendar or appointment metadata, from a background service that retrieved the user activity metadata from one or more third party services using one or more APIs. As another example, the application may receive user activity metadata from one or more applications or background processes executed by the first information handling system. As another example, the application may receive user activity metadata from one or more external information handling systems that are within a predetermined range of the first information handling system.

An information handling system may include processor and a memory configured to perform the steps described herein. Alternatively or additionally, a computer program product may include a non-transitory computer-readable medium comprising instructions to cause a processor to perform the steps described herein.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is an illustration of an example system for intelligent automated note tagging according to some embodiments of the disclosure.

FIG. 2 is an illustration of an example note tagged with user activity metadata according to some embodiments of the disclosure.

FIG. 3 is a flow chart diagram of an example method for automated note tagging with user activity metadata according to some embodiments of the disclosure.

FIG. 4 is a flow chart diagram of an example method for automated note tagging based on information received from a local information handling system according to some embodiments of the disclosure.

FIG. 5 is a flow chart diagram of an example method for tagging of a note with received calendar metadata according to some embodiments of the disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

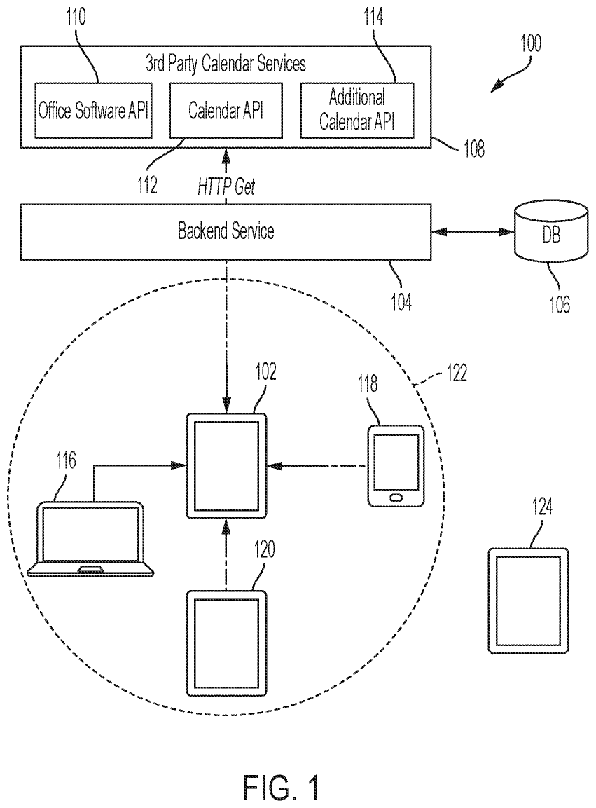

An application executed by a first information handling system, such as a notetaking application, may automatically aggregate user activity metadata for incorporation into notes generated by the notetaking application. An example system 100 for aggregation of user activity metadata into notes generated by a first information handling system 102 is shown in FIG. 1. The information handling system 102 may, for example, be a tablet, laptop, or other information handling system operated by a user. The information handling system 102 may execute a notetaking application for taking notes. A variety of input mechanisms may be used to input notes into the notetaking application executed by the first information handling system 102, such as a touch keyboard, a physical keyboard, voice input, touch interface finger input, touch interface stylus input, and other input mechanisms.

When a user generates a note on the first information handling system 102, the notetaking application of the first information handling system 102 may gather user activity metadata from a plurality of sources for incorporation into the note. Generation of a note may include creation of a new note, such as opening of a new note and entering information into the new note, or alteration of an existing note, such as opening of an existing note and addition of information to or alteration of information already present in the existing note. The user activity metadata may, for example, be data regarding user activity while the note was being generated, such as user activity while the note was opened and/or the user was adding information to or altering information contained in the note. In some embodiments, user activity metadata may include user activity metadata from one or more external sources of the first information handling system 102, such as one or more applications, other than the notetaking application, executed by the first information handling system 102 or one or more background processes of the first information handling system 102.

As one example, calendar, appointment, and/or other metadata may be received from a plurality of third party sources, and the note may be tagged with such metadata. Tagging a note with user activity metadata may include incorporation of the metadata into the note where the metadata is visible to a user. Tagging a note with user activity metadata may also include incorporation of user activity metadata in a note file where the metadata is not visible to a user or must be requested by a user for viewing. The user activity metadata may, for example, be calendar metadata. Calendar metadata may include, for example, metadata related to one or more meetings that overlapped in time with generation of the note, such as names of the meetings, attendees of meetings, documents created during or attached to a meeting file, a location of the meeting, a time of the meeting, and other information related to the meeting. In order to receive user activity metadata from third party sources, the information handling system 102 may request such metadata from a backend service 104 executed by a remote information handling system, such as a remote server. The backend service 104 may be connected to a remote database 106 for storing user activity metadata. The backend service 104 may request user activity metadata, such as calendar metadata, from one or more third party services 108. Third party services from which calendar metadata may be requested may include an office software API 110, such as a Microsoft Graph API, a calendar API 112, such as a Google Calendar API, or an additional calendar API 114. In some embodiments, the backend service 104 may request calendar information from multiple third party services using multiple APIs. The backend service 104 may perform a hypertext transfer protocol (HTTP) get function to obtain calendar metadata from one or more third party APIs. The backend service 104 may return the calendar metadata to the first information handling system 102, and the first information handling system 102 may tag the generated note with the calendar metadata.

The first information handling system 102 may also detect other information handling systems within a predetermined range 122 of the first information handling system. For example, the first information handling system may communicate with local information handling systems via a Bluetooth connection, such as a Bluetooth low energy (BLE) connection, a WiFi connection, or another wireless connection, to detect additional information handling systems 116, 118, 120 that are within a range of the first information handling system 102. The first information handling system 102 may determine a distance between the first information handling system 102 and the additional information handling systems 116, 118, 120, 124 to determine if the additional information handling systems 116, 118, 120, 124 are within the predetermined range 122 of the first information handling system 102. For example, some information handling systems 116, 118, 120 may be within the predetermined range 122, while other information handling systems 124 may not. In some embodiments, the predetermined range 122 may be a maximum range of one or more wireless antennas of the first information handling system 102. The notetaking application executed by the first information handling system 108 may request and receive user activity metadata from the information handling systems 116, 118, 120 that are within the predetermined range 122.

In some embodiments, the first information handling system 102 may determine whether the information handling systems 116, 118, 120 detected within the predetermined range. For example, the first information handling system 102 may determine that a first additional information handling system 116 is a laptop operated by the user of the first information handling system 102 and that the second additional information handling system 118 is a smart phone operated by the user of the first information handling system 102. The first information handling system 102 may request and receive user activity metadata from the first additional information handling system 116, such as metadata detailing files opened or generated by the user or messages sent by the user on the first additional information handling system 116 while generating the note on the first information handling system 102. File metadata may, for example, include titles of files, such as documents, locations of files, links to files, creators of files, creation times of files, and other data about the files The first information handling system 102 may, alternatively or additionally, request and receive user activity metadata from the second additional information handling system 118, such as calendar metadata from a calendar application executed by the second additional information handling system, location data from the second additional information handling system 118 while the note was being generated, metadata regarding messages sent by the second additional information handling system 118 while the note was being generated, and other user activity metadata from the second additional information handling system 118 from a time period during which the first note was generated.

The third additional information handling system 120 may, for example, be a tablet operated by a user different from the user operating the first information handling system 102. The first information handling system 102 may request and receive user activity metadata from the third additional information handling system 120. Such metadata may, for example, include an identity of the user operating the third additional information handling system 120. In some embodiments, metadata received from local information handling systems operated by users other than a user of the first information handling system 102, such as third additional information handling system 120, may include file metadata, such as metadata regarding files accessed or generated by the user of the third additional information handling system 120 while the note was being generated by the user of the first information handling system 102. For example, a link to a note generated by the different user of the third additional information handling system 120 or one or more tags associated with such a note may be requested and received by the first information handling system 102. In some embodiments, user identification metadata, such as names or usernames, and file user activity metadata may be shared by the third additional information handling system 120 only if authorized by the different user of the third additional information handling system 120. The note generated by the first information handling system 102 may then be tagged with the received user activity metadata. In some embodiments, when an information handling system operated by a different user is detected by the first information handling system 102, the first information handling system 102 may prompt a user with a query asking the user if the user would like to authorize user activity metadata sharing with the additional information handling system. If the user authorizes such sharing, the notetaking application of the first information handling system 102 may share user activity metadata, such as a username, note information, and/or note tags, with the additional information handling system.

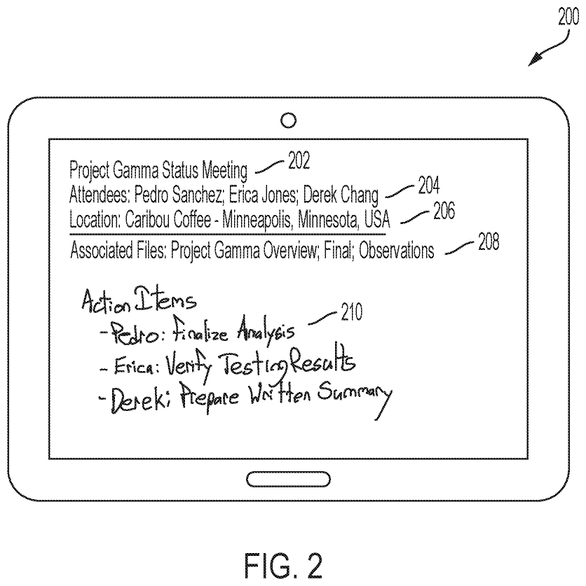

A note generated by a notetaking application of an information handling system may be tagged with user activity metadata received from one or more external sources. An example information handling system 200 with a note tagged with user activity metadata is shown in FIG. 2. The note may, for example, include text 210 written by a user. For example, the contents of the note may be handwritten text, input by a user via a touch screen. Alternatively or additionally, the note may include typed text input by a user via a touch screen or keyboard. The note may be tagged with user activity metadata requested by the notetaking application of the information handling system 200 while the note was being generated. The user activity metadata may, in some embodiments, incorporate the metadata into the note for display to a user. The user activity metadata may include, for example, a name 202 of a meeting during which the note was generated. The name of the meeting may have been received, by the notetaking application, from an information handling system within a predetermined range of the first information handling system or from one or more third party services through a backend service operated on a remote server. As another example, the user activity metadata may include the names 204 of meeting attendees. The names 204 of the meeting attendees may, for example, be received in calendar metadata, as disclosed herein, or may be received from one or more additional information handling systems detected as being within a predetermined range of the first information handling system 200 and determined to be operated by users other than a user of the first information handling system 200. For example, if the first information handling system 200 detects one or more additional information handling systems being operated by different users within a predetermined range of the information handling system 200 while a note is being generated, it may request user identification, such as usernames, from the one or more additional information handling systems for tagging the note. As another example, the user activity metadata may include a location 206 associated with generation of the note. The location 206 may, for example, be received in calendar metadata, as disclosed herein, or may be received from one or more additional information handling systems detected as being within a predetermined range of the first information handling system while the note was being generated. For example, the location 206 may be received from a smart phone of the user detected by the first information handlings system 200 while the note was being generated. As another example, the user activity metadata may include one or more file names 208 of files accessed by the user during generation of the note. For example, the file names 208 may be obtained from an additional local information handling system, such as an additional information handling system within a predetermined range of the information handling system 200. The file names 208 may, for example, be files created, accessed, or otherwise manipulated while the note was being generated. For example, if a user accesses a file on the user's laptop while taking a note on the information handling system 200, the information handling system 200 may receive a name of the file and/or a link to the file's location and may tag the note with the name and/or link of the file. Thus, the notetaking application 200 may automatically tag a note with metadata received from one or more external sources while the note was being generated.

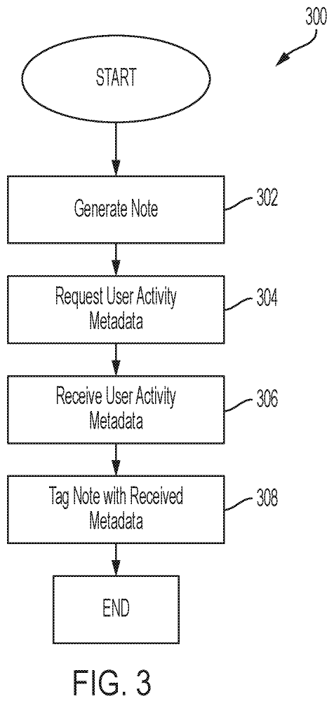

User activity metadata associated with a note may be automatically requested and tagged to a note to enhance utility of the note. An example method 300 for tagging a note with user activity metadata is shown in FIG. 3. The method 300 may begin, at step 302, with generation of a note by a notetaking application executed by an information handling system. Generation of a note may include creation of a new note, addition of content to an existing note, revision of content in an existing note, or other note manipulation.

At step 304, the notetaking application of the information handling system may request user activity metadata. For example, when the notetaking application begins generation of a note, the notetaking application may request user activity metadata from one or more external sources. Such sources may be external sources on the information handling system on which the notetaking application is being executed, such as applications or background processes other than the notetaking application, or may be external information handling systems, such as remote servers, local information handling systems, or other information handling systems.

At step 306, the notetaking application of the information handling system may receive user activity metadata. The notetaking application of the information handling system may aggregate received metadata from multiple sources, such as remote information handling systems and/or local information handling systems. In some embodiments, a software agent running on an additional information handling system or remote server may aggregate user activity metadata and may return the user activity metadata to the notetaking application of the information handling system.

At step 308, the notetaking application of the information handling system may tag the note with the received metadata. Tagging the note with the received metadata may include incorporating text of the received metadata into the note, such as dates, names, events, titles, links, and other received metadata. Thus, a note may be automatically tagged with relevant user activity metadata.

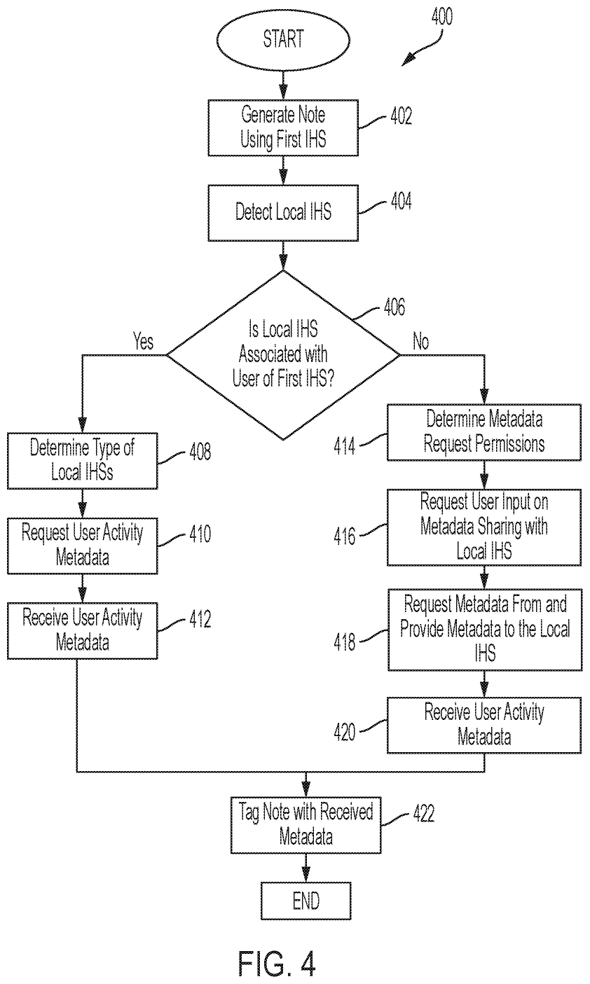

In some embodiments, a notetaking application executed by a first information handling system may receive user activity metadata from local information handling systems. Different metadata may be received from local information handling operated by the user and local information handling systems operated by different users. A method 400 for tagging notes with user activity metadata received from local information handling systems is shown in FIG. 4. The method 400 may begin, at step 402, with generation of a note by a notetaking application of a first information handling system. Such generation may be similar to the generation described with respect to step 302 of FIG. 3.

At step 404, the first information handling system may detect an additional information handling system. For example, the first information handling system may communicate using a Bluetooth, such as a Bluetooth low energy, signal, a WiFi signal, or another signal to determine if one or more information handling systems are within a predetermined range of the first information handling system. The predetermined range may, for example, be a range of 20 feet, 100 feet, or a different range.

At step 406, the first information handling system may determine whether the detected additional information handling system is associated with the user of the first information handling system. For example, the first information handling system may determine whether the additional local information handling system is associated with an account of a user different from the user of the first information handling system.

If the local additional information handling system is associated with the user of the first information handling system, the first information handling system may, at step 408, determine a type of the local additional information handling system. For example, the first information handling system may determine whether the local additional information handling system is a smart phone, a laptop, a desktop, a tablet, or a different kind of information handling system. In some embodiments, the first information handling system may request different kinds of user activity metadata from the local additional information handling system depending on the determined type of the local information handling system. For example, the first information handling system may request calendar and/or location metadata from the local additional information handling system if the local additional information handling system is determined to be a smart phone, while the first information handling system may request document activity metadata from the local additional information handling system if the local additional information handling system is determined to be a smart phone. As another example, if the user activity metadata is a smart phone user activity metadata may include phone numbers or names of individuals called using the smart phone while the note was being generated. User activity metadata may, for example, be collected by a software agent running on the smart phone, such as running on the iOS or Android operating systems, and may be returned to the first information handling system by the software agent. In some embodiments, the first information handling system may request user activity metadata from a local additional information handling system without determining a type of the local additional information handling system. For example, the first information handling system may make a general request for user activity metadata from the local additional information handling system, and the local additional information handling system may determine what user activity metadata to send to the first information handling system.

At step 408, the first information handling system may request user activity metadata from the local additional information handling system. For example, the first information handling system may request calendar metadata, location metadata, document activity metadata, or other user activity metadata from the first additional information handling system. Calendar metadata may, for example, include data regarding one or more events from a calendar application of the local additional information handling system that overlap in time or date with generation of the note, such as names of events or appointments, locations of events or appointments, descriptions of events or appointments, attendees of events or appointments, and other calendar metadata. Location metadata may, for example, include details about a location of the local additional information handling system while the note was being generated, such as an address at which the local additional information handling system was located, global positioning system (GPS) data detailing a location of the local additional information handling system, a name of a location at which the local additional information handling system was located, and other location information. Document activity metadata may, for example, include titles of files created or accessed while the note was being generated, links to such files, names of creators of such files, and other information regarding files created or accessed while the note was being generated. Such files may include presentation files, spreadsheet files, document files, note files, and other files. In some embodiments, the first information handling system may make a general request for user activity metadata from the first additional information handling system.

At step 412, the first information handling system may receive user activity metadata from the local additional information handling system. Such metadata may, for example, include metadata detailing files accessed or created on the additional information handling system while the note was being generated, calendar metadata detailing events or appointments overlapping in time with generation of the note, location data regarding a location of the additional information handling system while the note was being generated, and other user activity metadata. In some embodiments, a software agent run on the local additional information handling system may collect user activity metadata and may return the user activity metadata to the first information handling system. In some embodiments, the software agent may enable a remote copy/paste function and may allow transmission of copy/paste data to be tagged to the note on the first information handling system in addition to user activity metadata. Thus, for example, if content is copied from a document opened on the local additional information handling system to the first information handling system, user activity metadata detailing the document from which the content was copied, such as a title of the document and a location of the document, may be automatically tagged to the note. As another example, user activity metadata received by the first information handling system may include information regarding files from which content was copied and files to which content was copied on local additional information handling systems. Thus, if content is copied from a PDF file to a document on a local additional information handling system while the note was being generated, user activity metadata including details regarding the PDF file and the document may be received from the local additional information handling system. At step 422, the first information handling system may tag the note with the received user activity metadata. For example, the metadata may be inserted into the note. In some embodiments, the notetaking application may allow the user to edit the user activity metadata after it is tagged to the note.

If the first information handling system determined that the local additional information handling system was not associated with the user of the first information handling system, at step 406, the first information handling system may, at step 414, determine metadata request permissions. For example, the first information handling system may determine whether a user of the local additional information handling system has granted metadata sharing permissions to the first information handling system. In some embodiments, the first information handling system may request user activity metadata from the local additional information handling system without determining metadata request permissions. For example, the first information handling system may transmit a request for user activity metadata to the additional information handling system and the additional information handling system may determine what, if any, user activity metadata to return to the first additional information handling system. The additional information handling system may display a prompt to the different user of the additional information handling system inquiring as to whether the different user would like to share metadata with the first information handling system.

At step 416, the first information handling system may request user input on metadata sharing with the local additional information handling system. For example, when the local additional information handling system is detected, the first information handling system may inquire as to whether the user would like to share user activity metadata, such as information regarding notes generated while the first information handling system and the additional information handling system were in proximity. Such information may include names of notes generated, tags of notes generated, links to notes generated, a name of the user, and other user activity information. In some embodiments, a user may configure the notetaking application to share metadata openly with local additional information handling systems, and the first information handling system may share metadata with local additional information handling systems without prompting the user.

At step 418, the first information handling system may request user activity metadata from, and, if authorization was granted by the user, provide user activity metadata to the local additional information handling system. Such user activity metadata may, for example, include, usernames of the users of the information handling systems, information regarding documents accessed or created while the note was being generated, tags of notes, links to notes that were generated contemporaneously, and other user activity metadata. At step 420, the first information handling system may receive user activity metadata from the additional information handling system, and at step 422, the first information handling system may tag the generated note with the received user activity metadata. In some embodiments, the first information handling system may request and receive user activity metadata from multiple additional information handling systems, such as local information handling systems associated with the user and local information handling systems associated with different users.

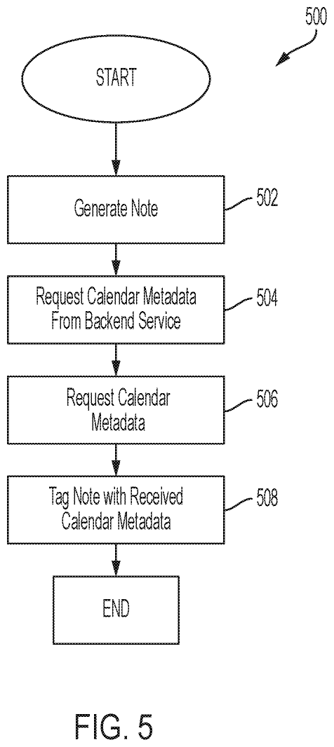

In some embodiments, a first information handling system may communicate with a backend service on a remote server to receive user activity metadata. An example method 500, shown in FIG. 5, for receipt of user activity metadata from a backend service may begin, at step 502, with generation of a note. At step 504, calendar metadata may be requested from a backend service. The backend service may, for example, be a service executed on a remote server, such as a remote server in a data center. The backend service may communicate with one or more third party calendar services. For example, the backend service may communicate with third party calendar services via one or more APIs. The backend service may request calendar metadata from the third party services, such as calendar metadata corresponding to a period during which the note was generated. For example, if the backend service receives the request at the beginning of generation of the note, the backend service may return calendar metadata relating to events with time frames that are at or near the beginning of generation of the note. In some embodiments, the backend service may collect calendar metadata from multiple third party services. In some embodiments, the user may perform a one time authorization to grant the backend service access to the third party calendar services. Calendar metadata may, for example, be requested for events or meetings having a start time that is within a predetermined time frame of generation of the note. For example, calendar metadata for events or meetings that begin within five minutes before and five minutes after opening or creating the note may be requested. Similar timing requirements may be applied when requesting calendar metadata from local additional information handling systems, such as tablets, laptops, or smart phones.

At step 506, the first information handling system may receive the calendar metadata. For example, the first information handling system may receive the calendar metadata from the backend service. At step 508, the first information handling system may tag the note with the received metadata. In some embodiments steps 502-508 may be performed by a notetaking application executed by the first information handling system. Thus, the first information handling system may automatically request and tag a note generated by the user with user activity metadata, such as calendar metadata.

The flow chart diagrams of FIGS. 3-5 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for tagging notes generated by a user of a first information handling system:
generating, by an application of the first information handling system, a note;
requesting, by the application of the first information handling system, user activity metadata from one or more external sources;
receiving, by the application of the first information handling system, user activity metadata from the one or more external sources; and
tagging, by the application of the first information handling system, the note with the received user activity metadata.

2. The method of claim 1, wherein requesting, by the application of the first information handling system, user activity metadata from one or more external sources comprises requesting, by the application of the first information handling system, user activity metadata from one or more external information handling systems.

3. The method of claim 2, wherein requesting, by the application of the first information handling system, user activity metadata from one or more external information handling systems comprises requesting calendar information for a time period during which the note was generated from a backend service operated on one or more of the external information handling systems.

4. The method of claim 2, further comprising:
detecting, by the application of the first information handling system, the one or more external information handling systems,
wherein detecting the one or more external information handling systems comprises determining that the one or more external information handling systems are associated with the user and located within a predetermined range of the first information handling system.

5. The method of claim 4, wherein receiving, by the application of the first information handling system, user activity metadata from the one or more external sources comprises receiving, from the one or more external information handling systems, one or more titles of one or more files that were accessed while the note was being generated.

6. The method of claim 4, wherein receiving, by the application of the first information handling system, user activity metadata from the one or more external sources comprises receiving, from the one or more external information handling systems, location data regarding one or more locations of the one or more external information handling systems.

7. The method of claim 2, further comprising:
detecting, by the application of the first information handling system, the one or more external information handling systems,
wherein detecting the one or more external information handling systems comprises determining that the one or more external information handling systems are associated with a different user and located within a predetermined range of the first information handling system, and
wherein receiving, by the application of the first information handling system, user activity metadata from the one or more external sources comprises receiving, from
the one or more external information handling systems, user activity data for the different user.

8. A first information handling system, comprising:
a processor; and
a memory,
wherein the processor is configured to perform steps comprising:
generating, by an application of the first information handling system, a note;
requesting, by the application of the first information handling system, user activity metadata from one or more external sources;
receiving, by the application of the first information handling system, user activity metadata from the one or more external sources; and
tagging, by the application of the first information handling system, the note with the received user activity metadata.

9. The first information handling system of claim 8, wherein requesting, by the application of the first information handling system, user activity metadata from one or more external sources comprises requesting, by the application of the first information handling system, user activity metadata from one or more external information handling systems.

10. The first information handling system of claim 9, wherein requesting, by the application of the first information handling system, user activity metadata from one or more external information handling systems comprises requesting calendar information for
a time period during which the note was generated from a backend service operated on one or more of the external information handling systems.

11. The first information handling system of claim 9, wherein the processor is further configured to perform steps comprising:
detecting, by the application of the first information handling system, the one or more external information handling systems,
wherein detecting the one or more external information handling systems comprises determining that the one or more external information handling systems are associated with the user and located within a predetermined range of the first information handling system.

12. The first information handling system of claim 11, wherein receiving, by the application of the first information handling system, user activity metadata from the one or more external sources comprises receiving, from the one or more external information handling systems, one or more titles of one or more files that were accessed while the note was being generated.

13. The first information handling system of claim 11, wherein receiving, by the application of the first information handling system, user activity metadata from the one or more external sources comprises receiving, from the one or more external information handling systems, location data regarding one or more locations of the one or more external information handling systems.

14. The first information handling system of claim 9, wherein the processor is further configured to perform steps comprising:
detecting, by the application of the first information handling system, the one or more external information handling systems,
wherein detecting the one or more external information handling systems comprises determining that the one or more external information handling systems are associated with a different user and located within a predetermined range of the first information handling system, and
wherein receiving, by the application of the first information handling system, user activity metadata from the one or more external sources comprises receiving, from the one or more external information handling systems, user activity data for the different user.

15. A computer program product, comprising:
a non-transitory computer readable medium, wherein the non-transitory computer readable medium comprises instructions for causing a first information handling system to perform steps comprising:
generating, by an application of the first information handling system, a note;
requesting, by the application of the first information handling system, user activity metadata from one or more external sources;
receiving, by the application of the first information handling system, user activity metadata from the one or more external sources; and
tagging, by the application of the first information handling system, the note with the received user activity metadata.

16. The computer program product of claim 15, wherein requesting, by the application of the first information handling system, user activity metadata from one or more external sources comprises requesting, by the application of the first information handling system, user activity metadata from one or more external information handling systems.

17. The computer program product of claim 16, wherein requesting, by the application of the first information handling system, user activity metadata from one or more external information handling systems comprises requesting calendar information for a time period during which the note was generated from a backend service operated on one or more of the external information handling systems.

18. The computer program product of claim 16, wherein the non-transitory computer readable medium further comprises instructions for causing the first information handling system to perform steps comprising:
detecting, by the application of the first information handling system, the one or more external information handling systems,
wherein detecting the one or more external information handling systems comprises determining that the one or more external information handling systems are associated with the user and located within a predetermined range of the first information handling system.

19. The computer program product of claim 18, wherein receiving, by the application of the first information handling system, user activity metadata from the one or more external sources comprises receiving, from the one or more external information handling systems, one or more titles of one or more files that were accessed while the note was being generated.

20. The computer program product of claim 18, wherein receiving, by the application of the first information handling system, user activity metadata from the one or more external sources comprises receiving, from the one or more external information handling systems, location data regarding one or more locations of the one or more external information handling systems.
